(19) United States
(12) Patent Application Publication
(10) Pub. No.: US 2014/0292210 A1
(43) Pub. Date: Oct. 2, 2014

(54) LOW POWER STANDBY SHUTDOWN CIRCUIT

(71) Applicant: KONINKLIJKE PHILIPS N.V., EINDHOVEN (NL)

(72) Inventors: Bernd Clauberg, Schaumburg, IL (US); Yuhong Fang, Naperville, IL (US); Alejandro Lopez, Lake Zurich, IL (US)

(73) Assignee: KONINKLIJKE PHILIPS N.V., EINDHOVEN (NL)

(21) Appl. No.: 14/353,933

(22) PCT Filed: Oct. 16, 2012
(86) PCT No.: PCT/IB12/55620

§ 371 Date: Apr. 24, 2014

Related U.S. Application Data
(60) Provisional application No. 61/551,529, filed on Oct. 26, 2011.

(51) Int. Cl. H05B 37/02

(52) U.S. Cl. CPC H05B 37/02
USPC 315/159

(57) ABSTRACT

A shut down circuit is disclosed that allows an electronic device such as a lamp driver to be turned-off with a small signal current. The shut down circuit requires only few components and allows a low-power consumption standby state since some or all of functionality of the electronic device can be turned off. In the one embodiment related to a lamp driver, wires of a 0-10V interface or Dali or other existing interface wires can be used so that no additional wires are needed. In addition, the shutdown circuit is galvanically isolated which allows connection to almost any external supply (low or high voltage, AC or DC).

This invention relates to a standby power shutdown circuit for an electronic device that may be turned off without disconnecting the main voltage and, more particularly, to a low power standby power shutdown circuit for controlling LED or other types of lamp drivers.

In many industrial, commercial or residential lighting systems, it would be desirable to have a way to turn off a driver with a low current interface. This would be useful for three reasons, first, because it would avoid wearing out mechanisms of relays by switching using low current, second, it would allow for the use of a solid state switch, and third, it would use less power than convention standby power circuits. It should be understood that driver as herein is used to include, but not limited to, LED drivers, ballasts for fluorescent lighting, electronic ballasts, HID or other type lamp drivers.

A conventional LED driver is a self-contained power supply that has outputs matched to the electrical characteristics of an LED or array of LEDs.

A conventional electronic lamp ballast uses solid state electronic circuitry to provide the proper starting and operating electrical condition to power one or more fluorescent lamps, HID lamps or other types of lamps.

In conventional lighting control applications, for example, LED drivers as well as other lamp drivers/ballasts typically require either a digital interface such as Digital Addressable Lighting Interface (DALI) to turn them off or an external power relay to turn off the line voltage. The digital interfaces can be expensive and external power relays can be expensive and unreliable due to wear out of the contacts over time.

A conventional DALI network consists of a controller and one or more lighting devices (e.g., electrical ballasts and dimmers) that have DALI interfaces. The controller monitors and controls each light by means of a bi-directional data exchange. The DALI protocol permits devices to be individually addressed or to simultaneously address multiple devices. Data is transferred between the controller and the devices by means of an asynchronous, half-duplex, serial protocol over a two-wire differential bus. Such conventional DALI devises require a single pair of wires to form the bus for communication to all devices on a single DALI network.

In the conventional DALI, as well as in other addressable driver systems, an off command requires the communication circuitry/means and the low voltage power supply to remain active (i.e., power on). This may consume up to 1W of energy during the off state of the driver.

According, a need exists in the art for a simple circuit that can be added to any electronic driver to provide a means of switching it off without disconnecting the main power supply input. One feature of such a needed simple circuit is that only a very small external current should be used (i.e., less than would normally be needed for an external relay) to operate the shutdown function. Another feature of such a needed simple circuit is that is should shut down some or all of the control circuitry inside the driver. This will allow for low standby power consumption to be achieved.

The present invention provides for a simple shut down circuit that allows any driver to be turned-off with a small signal current.

One aspect of the present invention relates to an interface that requires only a few components (e.g., in one embodiment only one component is required) while allowing for a low standby power state to be achieved because most, if not, all components/functionality of the driver can be turned off. For example, all internal ICs can be turned off and no internal low voltage supply is required to keep the driver in the off-state. In this aspect, a standby power consumption of less than 200 mW can be achieved.

In another embodiment using additional components, the standby power consumption can be reduced to almost zero power, i.e., less than or equal to 20 mW.

In another embodiment, the present invention relates to an electronic device including components connected to an input main voltage and a circuit for shutting down the components without disconnecting the input main voltage from the electronic device. The circuit includes an opto-isolator having a diode side and a transistor side. The diode side is coupled to an external power source and the transistor side is coupled to a control point within the electronic device so that on-state or off-state of the one or more internal components can be controlled.

In one aspect of the embodiment described in the preceding paragraph, the electronic device may be a lamp driver. The external power source is arranged to drive the diode side of the opto-isolator so that the transistor side of the opto-isolator is in an active state and where the active state is used to control the on-state and the off-state of the one or more internal components. When the transistor side of the opto-isolator is in the active state, a voltage at the control point within the lamp driver is either pulled down below a required operating voltage level or allowed to be at the required operating voltage level for operation so that the on-state or the off-state of an electronic ballast is controlled.

In still another embodiment, the present invention relates to a lighting driver that can be operated in a normal operating on-state or in a low-power consumption off-state without de-coupling the lighting driver from a main power source. The lighting driver includes at least one component arranged to provide a required operating electrical condition to power one or more types of lamps and a connect point arranged to receive a control signal from an external source. An opto-isolator is arranged to control, based upon the control signal, shutting down the at least one component.

In one aspect of this embodiment, the low power consumption off-state of the lighting driver consumes less than 200 mW of power.

In another aspect of the lighting driver embodiment described above, the low power consumption off-state consumes less than or equal to 20 mW of power.

In yet another embodiment, the present invention relates to an electrical device coupled to a main power source. The electrical device includes at least one component arranged to provide functionality needed for an output function of the electronic device and a connector arranged to receive a signal from an external input. The electrical device also includes means, including an opto-isolator, for placing the at least one component of the electrical device in a low-power consumption off-state in accordance with the signal without de-coupling the electrical device from main power source. The low-power consumption off-state consumes less than 200 mW of power.

In general, the various aspects and embodiments of the present invention may be combined and coupled in any way possible within the scope of the invention. The subject matter that is regarded as the invention is particularly pointed out and distinctly claimed in the claims at the conclusion of the specification.

The foregoing and other features and advantages of the invention will be apparent from the following detailed description taken in conjunction with the accompanying drawings.

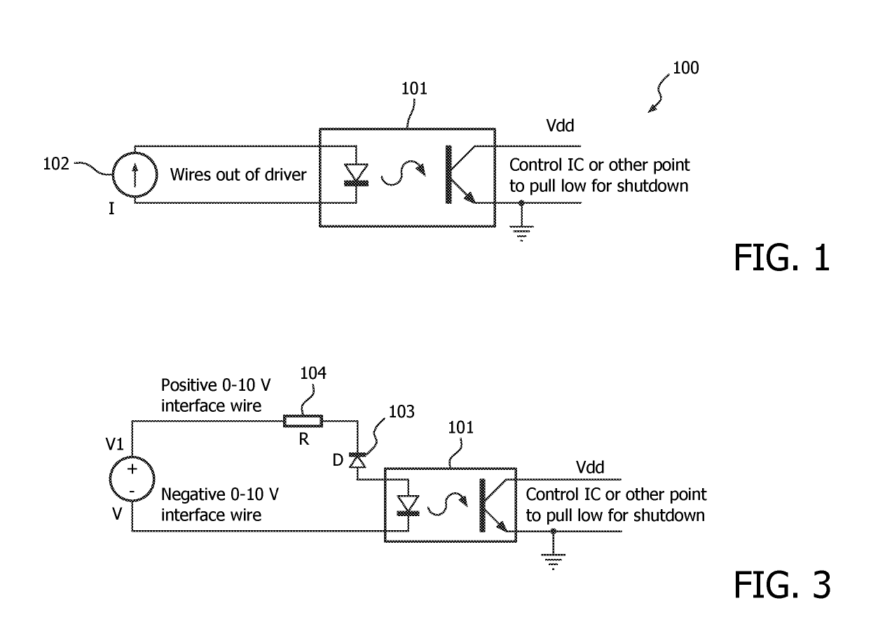

FIG. 1 shows a shutdown circuit 100 according to an embodiment of the invention.

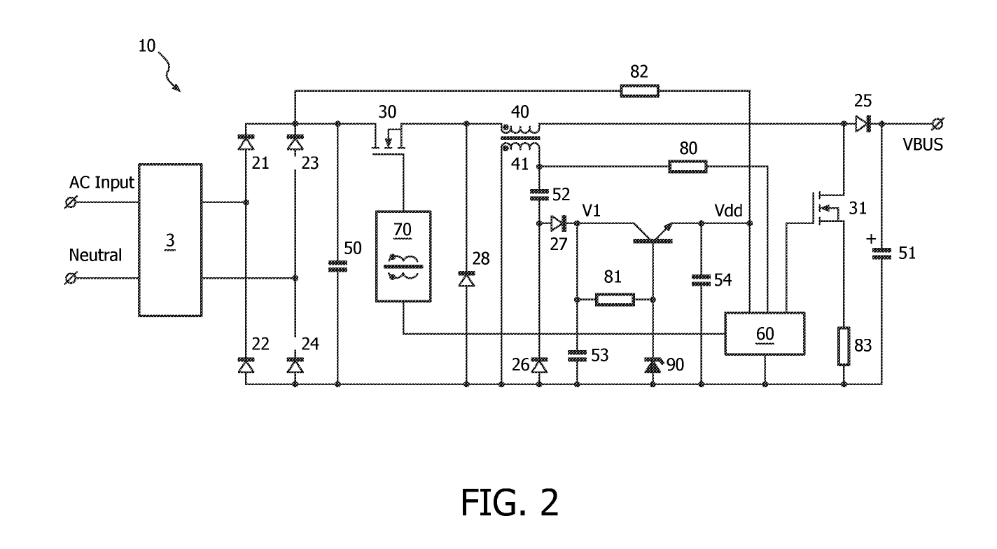

FIG. 2 shows a section of a conventional electronic ballast driver 10.

FIG. 3 shows a shutdown circuit 200 according to another embodiment of the invention.

According to the principles of the present invention an opto-isolator 101 (as shown in FIG. 1) is used to provide a means of shutting down a driver and enabling an off-state with low power consumption of the driver as compared to the convention shutdown means described above. The use of the opto-isolator 101 that is driven from an external source allows for easily shutting down control ICs or other driver functionality.

To illustrate how shut down is performed in accordance with one aspect of the present invention, reference is made to FIG. 2 which shows a “section of” a conventional electronic ballasts driver circuit 10. The driver circuit 10 includes an electromagnetic interference (EMI) filter 3, bridge diodes (21-24), a buck MOSFET 30, a Power Factor Correction (PFC) inductor 40, a boost MOSFET 31, a resistor 83, capacitors 50 and 51, diodes 25 and 28, and a PFC controller 60. The MOSFETs 30 and 31 are controlled by the PFC controller 60 and are controlled to turn On/Off at same time. The MOSFET 30 is driven through a driving circuit 70. The circuit 10 also includes a charge pump circuit (capacitor 52 and 53 and diodes 26, 27) and a linear voltage regulator (resistor 81, zener diode 90, transistor 33 and capacitor 55). When voltage is applied to input terminals 1 and 2, current via a resistor 82 charges a capacitor 54. When a voltage at Vdd (i.e., the voltage of the capacitor 54) reaches a start threshold, the PFC controller 60 starts to oscillate and drive the MOSFETs 30 and 31. The circuit 10 then starts to provide a high enough voltage to drive an output lamp.

In the embodiment shown in FIG. 1, an external current source 102 (this could be a simple 3.3V or 5V voltage supply in series with a resistor) is used to supply a current (e.g., in the order of 1 mA) to a diode side of the opto-isolator 101. The amount of driver current required to operate the opto-isolator 101 depends on the specifications of the particular type of component used, but the diode side driver current is generally less than 5 mA (even less than 1 mA is possible). A transistor side of the opto-isolator 101 is coupled so that it causes the shutdown of driver functionality. In this embodiment, when the diode side driver current is not supplied to the diode side of the opto-isolator 101, the Vdd reference point is pulled down below the necessary operating voltage level which causes shut down of the driver circuit 10.

But it should be understood that other implementations (couplings) are possible to cause shut down. In this regard, the opto-isolater 101 may be used to short-out or reduce a voltage or signal of an internal circuit node (i.e., a control point) such that functionality is stopped or similarly affected to cause the driver circuit 10 to the turn-off. For example, a typical LED driver circuit may generally consist of one IC with a few additional components (resistors, capacitors and a MOSFET). The opto-isolator 101 of FIG. 1 may be used to pull down a Vcc voltage (i.e., the voltage regulator output that supplies the power to the internal circuitry of the driver) or it may be used to activate a shut-down function on a control IC if so equipped.

For example, in one implementation, the control IC may be a TEA1713. The TEA1713 integrates a Power Factor Corrector (PFC) controller and a controller for a Half-Bridge resonant Converter (HBC) in a multi-chip IC. The TEA1713 provides the drive function for a discrete MOSFET in an up-converter and for the two discrete power MOSFETs in a resonant half-bridge configuration. Efficient and reliable power supplies can be designed easily using the TEA1713, with a minimum of external components. In this embodiment, the opto-isolator 101 is coupled to the AC line voltage and the output control signal is coupled to a disable pin on the control IC TEA1713. In this implementation of the present invention, the standby power is below 200 mW at 277V input line and below 20 mW at 120V input line.

As one of ordinary skill in the art will appreciate, the driver current from external current source 102 will essentially turn the transistor side of the opto-isolator 101 on/off. Intiating (i.g., providing) the driver current can be done via various existing lighting control arrangements such as: a remote control signal/interface, a manual switch, an automated control interface, etc. Since the external source 102 provides the energy to activate the opto-isolator 101, no internal supplies are needed in the driver circuit 10 so that an off-state power consumption can approach zero (all or almost all functionality of the driver circuit 10 can be turned off).

Also considering that the opto-isolator 101 is isolated, it can be placed almost anywhere in a driver circuit 10 to shut down one or more energy consuming components of the driver circuit 10. The isolation makes it possible to use the embodiment shown in FIG. 1 for nearly any type of driver configuration. For example, floating power supply ICs or other low voltage supplies can also be turned-off using aspects of the embodiment shown in FIG. 1. There are also a wide range of optos-isolators available that would allow any level of isolation that may be required in a particular application and are even available in a bi-directional configuration, or allowing shut down with an AC signal or positive or negative DC signals.

It should also be understood by one of ordinary skill in the art that the wires of a 0-10V interface or the Dali or other interface wires can be used, so no additional wires (i.e., connection points, connectors or terminals) are needed. The Dali interface has been discussed above and below the 0-10V interface is discribed.

The 0-10V interface is an analog lighting control protocol. The 0-10V control protocol applies a voltage between 0 and 10 volts DC to produce a varying intensity level. The 0-10V control protocol is used as a means for controlling fluorescent dimming ballasts and for some drivers used for LED lighting as well as some eHID ballasts.

FIG. 3 shows another embodiment of the present invention where the opto-isolator 101 is placed in series with a clamping zener diode 103 typically found in the 0-10V dimming interfaces. As shown in FIG. 3, this embodiment of the present invention does not require any additional wires (or connection points, connectors or terminals), but uses the existing 0-10V wires and it's protection circuitry. In this embodiment, the opto-isolator 101 is activated by applying a voltage that exceeds a clamping zener voltage (V1) to the 0-10V wires. For example, if a 13V zener diode is used, then a 15V signal could be used. An external current limiting resistor 104 may need to be used if it is not already in the driver design.

It should be understood that this embodiment allows the use of the 0-10V interface without interfering with the 0-10V functionality. Also typically, the resistor 104 and the zener diode 103 are already used in the 0-10V interface, so that this shutdown functionality can be added with a single component.

In yet another embodiment of the present invention, the opto-isolator 101 in FIG. 3 can a bi-directional opto-isolator. This allows for not only a positive signal to be used to initiate the shut down of the driver circuit 10, but also a small negative voltage can be used (less than 5V). Because of the isolation provided by these embodiments, the negative voltage is easily obtained by reversing dimming wires and connecting to a positive supply. In addition, the V1 voltage is not limited to DC voltages. An AC signal (V1) applied to the circuit in FIG. 3 where opto 101 is replaced with a bi-directional opto would cause Vdd to be shorted at the frequency of the AC source. If the components connected at the transistor side of 101 are chosen properly, a delay can be introduced that delays startup of the controller after shutdown. By making sure that this delay is longer than the period of the AC signal applied, shut-down can be maintained.

As can be seen from the embodiments and aspects discribed above, the shutdown circuit of the present invention provides an effective and needed solution to shut down nearly any electronic circuit with very few components (a single component as show in FIG. 3). For example, besides lighting ballasts and drivers, embodiments and aspects of the present invention can also be used with end-user appliance devices which function through on/off control. For example, such devices may include heaters, motors, industrial electrical equipment or other appliances.

The foregoing detailed description has set forth a few of the many forms that the invention can take. The above examples are merely illustrative of several possible embodiments of various aspects of the present invention, wherein equivalent alterations and/or modifications will occur to others skilled in the art upon reading and understanding of the present invention and the annexed drawings. In particular, regard to the various functions performed by the above described components (devices, systems, circuits, and the like), the terms (including a reference to a “means”) used to describe such components are intended to correspond, unless otherwise indicated to any component, such as hardware or combinations thereof, which performs the specified function of the described component (i.e., that is functionally equivalent), even though not structurally equivalent to the disclosed structure which performs the function in the illustrated implementations of the disclosure.

Although a particular feature of the present invention may have been illustrated and/or described with respect to only one of several implementations, such feature may be combined with one or more other features of the other implementations as may be desired and advantageous for any given or particular application. Furthermore, references to singular components or items are intended, unless otherwise specified, to encompass two or more such components or items. Also, to the extent that the terms “including”, “includes”, “having”, “has”, “with”, or variants thereof are used in the detailed description and/or in the claims, such terms are intended to be inclusive in a manner similar to the term “comprising”.

The present invention has been described with reference to the preferred embodiments. However, modifications and alterations will occur to others upon reading and understanding the preceding detailed description. It is intended that the present invention be construed as including all such modifications and alterations. It is only the claims, including all equivalents that are intended to define the scope of the present invention.

1. An electronic device that may be turned off without disconnecting an input main voltage, comprising:
one or more internal components coupled to the input main voltage,
a circuit for shutting down the one or more internal components without disconnecting the input main voltage from the electronic device, the circuit including:
an opto-isolator including a diode side and a transistor side, the diode side being arranged to be coupled to an external power source and the transistor side being connected to a control point within the electronic device so that an on-state or an off-state of the one or more internal components can be controlled;
wherein the external power source is arranged to drive the diode side of the opto-isolator so that the transistor side of the opto-isolator is in an active state and where the active state is used to control the on-state and the off-state of the one or more internal components; and
wherein when the transistor side of the opto-isolator is in the active state, a voltage at the control point within the electronic device is either pulled down below a required operating voltage level or allowed to be at the required operating voltage level for operation so that the on-state or the off-state of the one or more internal components is controlled.

2. The electronic device according to claim 1, wherein the electronic device is a lamp driver.

3. (canceled)

4. (canceled)

5. The electronic device according to claim 1, wherein the voltage at the control point is the voltage output that supplies power to the one or more internal components.

6. The electronic device according to claim 1, wherein the voltage at the control point is a start threshold voltage of the lamp driver.

7. The electronic device according to claim 1, wherein the external power source is a current source that is arranged to drive the diode side of the opto-isolator with a current of less than or equal to 5 mA.

8. The electronic device according to claim 2, wherein the diode side of the opto-isolator is coupled to external power source using a 0-10V dimming interface or a DALI interface.

9-19. (canceled)

20. A method for operating a lighting driver in a normal operating on-state or in a low power consumption off-state without de-coupling the lighting driver from a main power source, the method comprising:
providing, by at least one component of the lighting driver, a required operating electrical condition to power one or more types of lamps;
receiving, at a connect point of the lighting driver, a control signal from an external source;
driving a diode side of an opto-isolator based upon the control signal so that a transistor side of the opto-isolator is in an active state; and
when the transistor side of the opto-isolator is in the active state, pulling a voltage at the connect point within the lighting driver below a required operating voltage level or allowing the connect point to be at the required operating voltage level for operation, so that shutting down of the at least one component is controlled.

21. The method according to claim 7, wherein the one or more types of lamps comprise at least one LED.

22. The method according to claim 7, wherein the one or more types of lamps comprise either a fluorescent or HID type lamp.

23. The method according to claim 7, wherein the at least one component is an electronic ballast.

24. The method according to claim 7, further comprising consuming, by the at least one component while in the low power consumption off-state, less than 200 mW of power.

25. The method according to claim 7, further comprising consuming, by the at least one component while in the low power consumption off-state, less than or equal to 20 mW of power.

26. The method according to claim 7, wherein in the connect point is a DALI interface.

27. The method according to claim 7, wherein in the connect point is a 0-10V interface.
